(19) United States
(12) Patent Application Publication
(10) Pub. No.: US 2007/0228971 A1
(43) Pub. Date: Oct. 4, 2007

(54) PLASMA DISPLAY PANEL

(75) Inventors: Kyoung-Doo Kang, Suwon-si (KR); Won-Ju Yi, Suwon-si (KR); Ho-Young Ahn, Suwon-si (KR); Dong-Young Lee, Suwon-si (KR); Soo-Ho Park, Suwon-si (KR); Seok-Gyun Woo, Suwon-si (KR); Jae-Ik Kwon, Suwon-si (KR)

Correspondence Address: STEIN, MCEWEN & BUI, LLP, 1400 EYE STREET, NW, SUITE 300, WASHINGTON, DC, 20005, US

(73) Assignee: Samsung SDI Co., Ltd., Suwon-si (KR)

(21) Appl. No.: 11/689,730

(22) Filed: Mar. 22, 2007

(30) Foreign Application Priority Data
Mar. 28, 2006 (KR) 2006-28113

(51) Int. Cl. H01J 17/49

(52) U.S. Cl. 313/584; 313/585

(57) ABSTRACT

A plasma display panel including a first substrate; a second substrate spaced apart from the first substrate and to face the first substrate; a plurality of barrier ribs disposed between the first substrate and the second substrate to define a plurality of discharge cells between the first and second substrates; and a plurality of pairs of discharge electrodes buried in the barrier ribs to surround at least a portion of each of the discharge cells, wherein the discharge cells are disposed in a zigzag fashion.

### CROSS-REFERENCE TO RELATED PATENT APPLICATIONS

This application claims the benefit of Korean Patent Application No. 2006-28113, filed Mar. 28, 2006, in the Korean Intellectual Property Office, the disclosure of which is incorporated herein in its entirety by reference.

### BACKGROUND OF THE INVENTION

1. Field of the Invention

Aspects of the present invention relate to a plasma display panel, and more particularly, to a plasma display panel having a new structure capable of increasing discharge intensity and discharge efficiency by maximizing the cross-sectional area of the discharge cells with respect to a display area.

2. Description of the Related Art

Plasma display panel (PDP) display devices, which have generally replaced conventional cathode ray tube (CRT) display devices, display desired images by applying a discharge voltage between the two substrates on which a plurality of electrodes is formed to a sealed discharge gas in discharge cells. The discharge gas then emits ultraviolet photons, which, in turn, excite electrons of phosphors. The excited electrons emit visible light when the electrons return to the previous energy state. The discharge cells are arranged in a predetermined pattern so that an image can be displayed.

FIG. 1 is an exploded perspective view of a conventional plasma display panel (PDP).

Referring to FIG. 1, a typical alternating current (AC) type PDP 10 includes a front plate 50, through which images are displayed, and a rear plate 60 coupled and parallel to the front plate 50. Pairs of sustain electrodes 12 each comprising an X electrode 31 and a Y electrode 32 are formed on a front or first substrate 11 of the front plate 50. Address electrodes 22 crossing the X and Y electrodes 31 and 32 of the first substrate 11 are disposed on a second substrate 21 of the rear plate 60 facing the surface of the first substrate 11 and disposed between the rear plate 60 and the front plate 50. Further, each of the X and Y electrodes 31 and 32 includes transparent electrodes 31a and 32a, respectively, and bus electrodes 31b and 32b formed thereon.

A first dielectric layer 15 that protects pairs of the sustain electrodes 12 is formed on the first substrate 11. And, a second dielectric layer 25 that protects the address electrodes 22 are formed on the second substrate 21. The first dielectric layer 15 and the second dielectric layer 25 are formed on the surfaces of the front plate 50 and the rear plate 60, respectively, that face each other. A protective layer 16, usually formed of MgO, is disposed in a rear surface of the first dielectric layer 15, meaning that the protective layer 16 is disposed on the surface of the first dielectric layer 15 between the first dielectric layer 15 and the rear plate 60. Barrier ribs 30 that provide a discharge distance and prevent electrical and optical cross-talk between discharge cells are formed on the front surface of the second dielectric layer 25, meaning that the barrier ribs 30 are disposed on the surface of the second dielectric layer 25 between the second dielectric layer 25 and the front plate 50.

Red, green, and blue phosphor layers 26 coat both sides of the barrier ribs 30 and on the front surface of the second dielectric layer 25 where the barrier ribs 30 are not formed.

Visible light emitted from the phosphor layers 26 of each discharge area is transmitted through the front plate 50 of the conventional surface discharge type PDP 10 when a discharge is generated. However, the transmission ratio of visible rays is only about 60% due to the various constituents formed on the front plate 50.

Generally, in the conventional PDP 10, electrodes are formed on upper sides of each discharge area, i.e., the electrodes are formed on the inner surface of the front plate 50 or the surface of the front plate 50 that faces rear plate 60. Thus, the discharge efficiency of each discharge cell is reduced as the visible light produced to be displayed as an image travels through the front plate 50, which is congested by elements of the PDP 10 disposed on the surface of the front plate 50.

When the conventional PDP 10 is driven for a long time, charged particles of a discharge gas are accelerated by an electric field and sputter ions from the phosphor layers 16, which results in the formation and display of an afterimage.

The conventional PDP 10, including stripe- and grid-type discharge cells, limited discharge areas since the aperture of each discharge area is determined according to a cell pitch 70. In particular, the limited discharge areas may be disadvantageous as discharge intensity and luminous efficiency of PDPs are determined according to the cross-sectional area of each discharge cell and interrupted by elements formed on the front plate 50.

### SUMMARY OF THE INVENTION

Aspects of the present invention provides a plasma display panel (PDP) having a structure where discharge electrodes surround each discharge cell and discharge cells are disposed in a zigzag fashion with respect to a horizontal axis at a predetermined angle, which increases the cross-sectional area of the discharge cells, thereby increasing discharge intensity and luminous efficiency of the PDP.

According to an aspect of the present invention, there is provided a plasma display panel including a first substrate; a second substrate spaced apart from the first substrate and facing the first substrate; a plurality of barrier ribs disposed between the first substrate and the second substrate to define a plurality of discharge cells between the first and second substrates; and a plurality of pairs of discharge electrodes buried in the barrier ribs to surround at least a portion of each of the discharge cells, wherein the discharge cells are disposed in a zigzag fashion.

The discharge cells may have circular or oval cross-sections.

Each of the discharge cells may be a sub-pixel, with a plurality of sub-pixels forming a main pixel, and the discharge cells are disposed so that the sub-pixels form triangles in the main pixel.

The discharge cells may be disposed so that each triangle has inside angles of 60 degrees.

The plasma display panel may further comprise: grooves formed on the first substrate facing the discharge cells, and phosphors coated in the grooves to form phosphor layers.

Each of the pairs of discharge electrodes may comprise a first discharge electrode and a second discharge electrode, which are spaced apart from each other in a direction from the first substrate to the second substrate.

The first discharge electrodes and the second discharge electrodes may extend parallel to each other.

The plasma display panel may further comprise: address electrodes spaced apart from the pairs of discharge electrodes in the direction from the first substrate to the second substrate, and extending to cross the pairs of discharge electrodes, wherein the address electrodes surround at least a portion of each of the discharge cells formed in a direction in which the address electrodes extend.

The plasma display panel may further comprise: address electrodes formed on the second substrate and extending to cross the pairs of discharge electrodes.

The plasma display panel may further comprise: a dielectric layer formed on the second substrate to bury the address electrodes and formed of a dielectric substance.

The first discharge electrodes and the second discharge electrodes may extend to cross each other.

According to an aspect of the present invention, there is provided a plasma display panel comprising: a first substrate; a second substrate spaced apart from the first substrate and facing the first substrate; a plurality of barrier ribs disposed between the first substrate and the second substrate to define a plurality of discharge cells between the first and second substrates; a plurality of pairs of discharge electrodes buried in the barrier ribs to surround at least a portion of each of the discharge cells; and phosphor layers formed in the discharge cells and formed of a phosphor substance; and wherein the discharge cells are red, green, or blue sub-pixels, with each group of red, green, and blue sub-pixels constituting a main pixel, and the discharge cells are disposed so that lines connecting centers of the red, green, or blue sub-pixels form triangles in the main pixel.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an exploded perspective view of a conventional plasma display panel (PDP);

FIG. 2 is a partially exploded perspective view illustrating a PDP according to aspects of the present invention;

FIG. 3 is a cross-sectional view illustrating discharge cells and electrodes of the PDP of FIG. 2;

FIG. 4 is a cross-sectional view of the PDP of FIG. 2 taken along a line IV-IV of FIG. 2;

FIG. 5 is a cross-sectional view illustrating discharge cells and electrodes of the PDP of FIG. 2;

FIG. 6 is a partially exploded perspective view illustrating a PDP according to aspects of the present invention;

FIG. 7 is a cross-sectional view illustrating discharge cells and electrodes of the PDP of FIG. 6;

FIG. 8 is a cross-sectional view of the PDP of FIG. 6 taken along a line VIII-VIII of FIG. 6;

FIG. 9 is a cross-sectional view illustrating discharge cells and electrodes of a PDP according to aspects of the present invention; and

FIG. 10 is a cross-sectional view of the PDP of FIG. 9.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

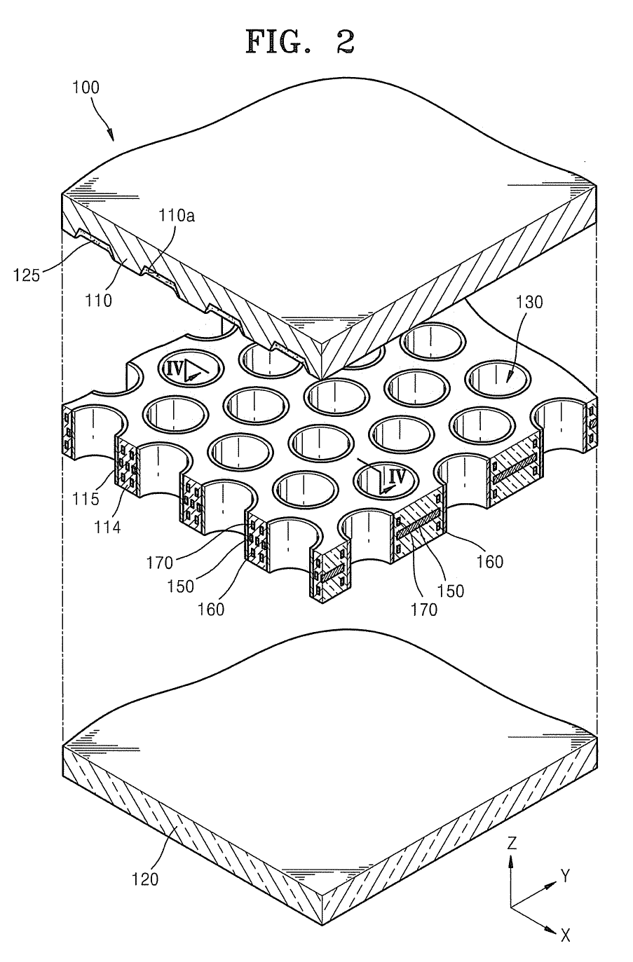

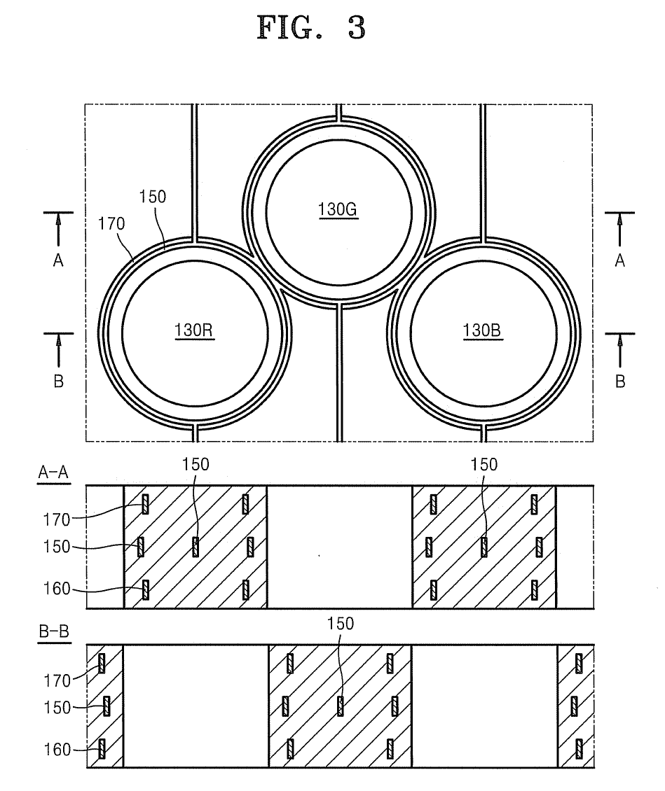

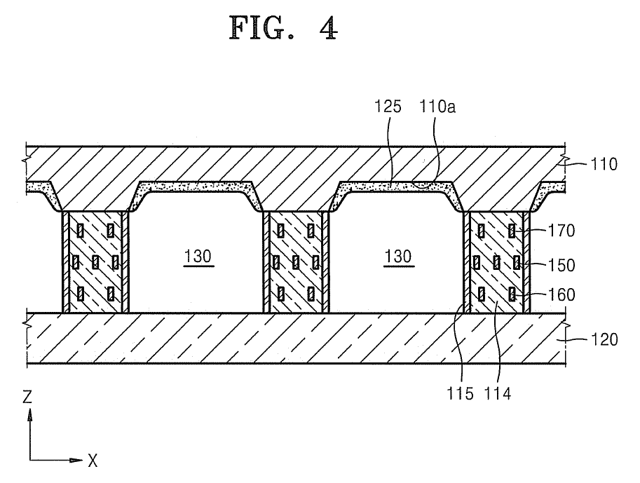

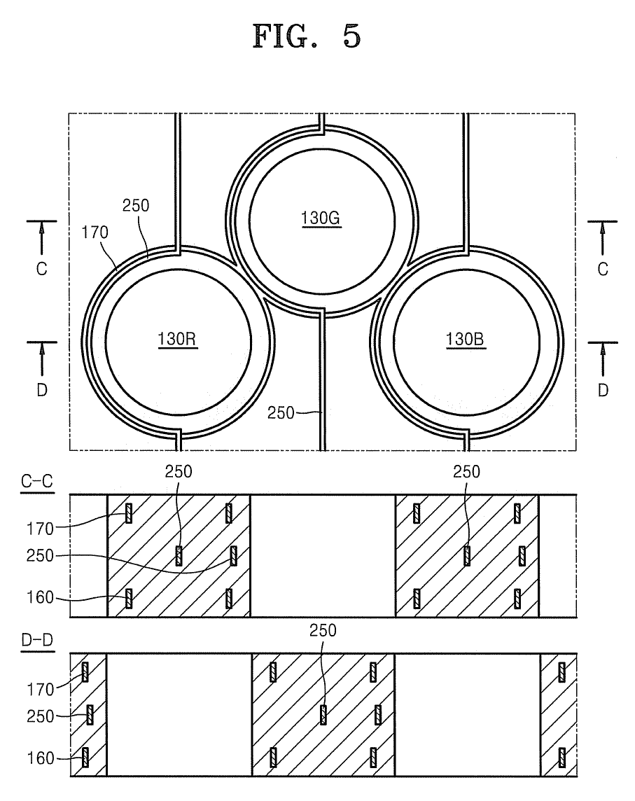

FIG. 2 is a partially exploded perspective view illustrating a PDP 100 according to aspects of the present invention. FIG. 3 is a cross-sectional view illustrating discharge cells and electrodes of the PDP of FIG. 2. FIG. 4 is a cross-sectional view of the PDP of FIG. 2 taken along a line IV-IV of FIG. 2. FIG. 5 is a cross-sectional view illustrating discharge cells and electrodes of the PDP of FIG. 2.

Referring to FIG. 2, the PDP 100 includes a first substrate 110 in which grooves 110a are formed, a second substrate 120, barrier ribs 114, protective layers 115, phosphor layers 125, first discharge electrodes 160, and second discharge electrodes 170. FIG. 2 also includes address electrodes 150.

The first substrate 110 is formed of glass having excellent transmittance. The first substrate 110 can be colored, which reduces reflective brightness in order to increase contrast in a bright room.

The second substrate 120 is spaced apart from the first substrate 110 by a predetermined gap and faces the first substrate 110. The first substrate 110 and the second substrate 120 define a plurality of discharge cells 130 in which a discharge is generated and non-discharge cells (not shown) between the discharge cells 130. The second substrate 120 is formed of glass having excellent transmittance, and can also be colored.

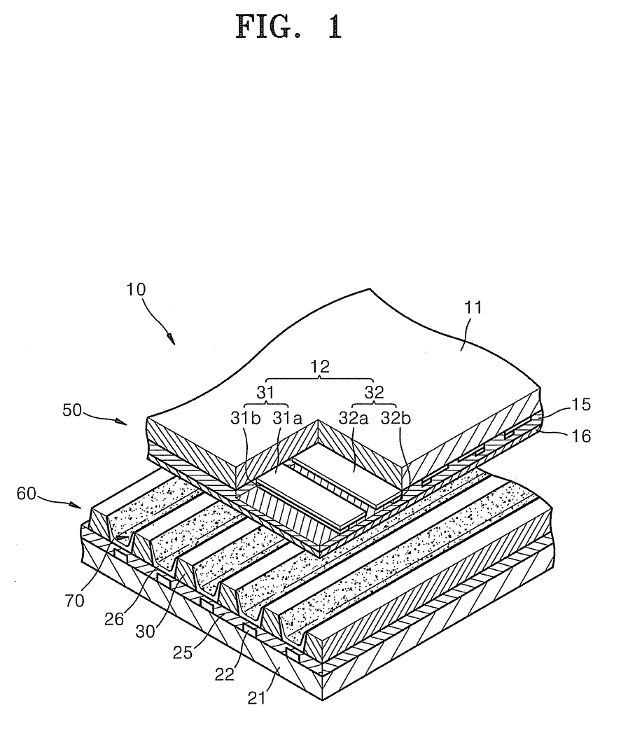

According to aspects of the present invention, visible light generated in the discharge cells 130 pass through the first substrate 110. In contrast to the conventional PDP 10 as illustrated in FIG. 1, structures corresponding to the first dielectric layer 15, the protective layer 16, and the X electrodes 31 and Y electrodes 32 that are formed on the front or first substrate 11 are not formed on the first substrate 110; therefore, the transmission ratio of visible light can be remarkably increased. When the PDP 100 displays an image having the conventional brightness, the first discharge electrodes 160 and the second discharge electrodes 170 can be driven at a relatively low voltage.

Referring to FIGS. 2 and 3, the barrier ribs 114 are disposed between the front or first substrate 110 and the rear or second substrate 120, define the discharge cells 130, and prevent optical and electrical cross-talk between the adjacent discharge cells 130. In various aspects, although discussed in terms of a particular orientation such as front or rear for ease of description, various elements need not be so oriented. In various aspects, the elements are independent of the specific orientation and should be viewed in their relative locations compared to other elements. Here, the barrier ribs 114 define discharge cells 130 having circular cross-sections, but the present invention is not limited thereto.

The discharge cells 130 can have other cross-sectional shapes including oval cross-sections. Furthermore, the barrier ribs 114 can have a variety of patterns so as to define the discharge cells 130. For example, the barrier ribs 130 may define the discharge cells 130 to have polygonal cross-sections, such as triangular, tetragonal, or pentagonal cross-sections.

The discharge cells 130 are disposed in a zigzag fashion so that the cross-sectional area of the discharge cells 130 is maximized with respect to a given panel area, resulting in increases in brightness and discharge efficiency. Essentially, a discharge density is increased as the cross-sectional area of the discharge cells 130 increases with respect to a given panel area. The discharge cells 130 are disposed in a zigzag fashion meaning that, in a direction, the centers of the discharge cells 130 are disposed about the direction such that the average deflection of the centers from the direction is zero.

In particular, as electrodes surround each discharge cell 130, the discharge intensity and degree of luminosity are determined according to the cross-sectional area of the discharge cells 130, here the diameter of each discharge cell 130, instead of by the elements formed on the first substrate 110. In the PDP 100, in which electrodes surround each discharge cell 130, red, green, and blue light-emitting discharge cells are disposed in a zigzag fashion, thereby maximizing discharge density. Referring to FIG. 3, the first discharge electrodes 160 and the second discharge electrodes 170 are connected in a zigzag fashion according to the red, green, and blue light-emitting sub-pixels, 130R, 130G, and 130B, respectively.

The discharge cells 130 are red, green, and blue sub-pixels 130R, 130G, and 130B, respectively, according to the types of phosphor layers 125 disposed in each discharge cell 130. A group of one red, one green, and one blue sub-pixels, 130R, 130G, and 130B, respectively, forms a main pixel. The discharge cells 130 are disposed so that lines connecting the centers of a red, a green, and a blue sub-pixels 130R, 130G, and 130B, respectively, cross each other at a predetermined angles. The lines can form triangles. Each triangle formed may have inside angles of 60 degrees so that the discharge cells 130 can be disposed in the shape of a delta.

The first discharge electrodes 160 and the second discharge electrodes 170 are buried or disposed in the barrier ribs 114. According to aspects of the present invention, the first discharge electrodes 160 and the second discharge electrodes 170 are formed on the barrier ribs 114, and a dielectric layer and a protective layer can be formed on the first discharge electrodes 160 and the second discharge electrodes 170.

The first discharge electrodes 160 and the second discharge electrodes 170 comprise pairs and generate the discharge in the discharge cells 130. Each of the first discharge electrodes 160 and the second discharge electrodes 170 extend in a first direction (the X direction) and surround the discharge cells 130, which are disposed in a zigzag fashion in the first direction. The first discharge electrodes 160 and the second discharge electrodes 170 connect the individual discharge cells in the first direction. Specifically in FIG. 3, the second discharge electrodes 170 can be seen as extending in the first direction and surrounding the discharge cells 130. In FIG. 3, the second discharge electrodes 170 are illustrated as connecting the three red, green, and blue sub-pixels 130R, 130G, and 130B. The second discharge electrodes 170 are connected circles arranged about the discharge cells 130 in a zigzag pattern such that the centers of the circles formed by the second discharge electrodes 170 form a zigzag.

The second discharge electrodes 170 are disposed generally parallel to the first discharge electrodes 160 in the barrier ribs 114 and are spaced apart from the first discharge electrodes 160 in a third direction perpendicular to the surface of the first substrate 110 (in a Z direction). Or, as the first discharge electrodes 160 and the second discharge electrodes 170 extend and connect discharge cells in the first direction, the first discharge electrodes 160 and the second discharge electrodes 170 are separated by a distance in the third direction wherein the first direction is parallel to the disposition of the first substrate 110 and the second substrate 120, and the third direction extends from the first substrate 110 to the second substrate 120.

The first discharge electrodes 160 and the second discharge electrodes 170 have circular loop shapes but the present invention is not limited thereto. The first discharge electrodes 160 and the second discharge electrodes 170 surround at least a portion of each of the discharge cells 130. The first discharge electrodes 160 and the second discharge electrodes 170 can partially or wholly surround each of the discharge cells 130. The first discharge electrodes 160 and the second discharge electrodes 170 can have various shapes including rectangular loop shapes, and may substantially have the same shape as the cross-sections of the discharge cells 130.

Address electrodes 150 extend in a second direction (in a Y direction) and cross the first discharge electrodes 160 and the second discharge electrodes 170. The address electrodes 150 extend linearly in the second direction but are interrupted by circular portions formed about the red, green, and blue sub-pixels 130R, 130G, and 130B; however, the address electrodes 150 are not limited thereto. As illustrated in FIG. 5, the address electrodes only surround a portion of the red, green, and blue sub-pixels 130R, 130G, and 130B such that the address electrodes extend in the second direction but are interrupted by semi-circular portions formed about the red, green, and blue sub-pixels 130R, 130G, and 130B. The address electrodes 150 extend in the second direction which is parallel to the disposition of the first substrate 110 and the second substrate 120. The address electrodes 150 are spaced apart from the first discharge electrodes 160 and the second discharge electrodes 170 in the third direction (in the Z direction) and disposed between the first discharge electrodes 160 and the second discharge electrodes 170 in the barrier ribs 114.

The address electrodes 150 surround at least a portion of each of the discharge cells 130. The address electrodes 150 can partially or wholly surround each of the discharge cells 130. In FIGS. 2 through 4, the address electrodes 150 surround the whole part of each of the discharge cells 130. In FIG. 5, the address electrodes 250 surround a part, i.e., half, of each of the discharge cells 130.

As represented in FIGS. 2 through 5, the second discharge electrodes 170, the address electrodes 150 and 250, and the first discharge electrodes 160 are sequentially disposed in the Z direction, or the third direction, which reduces an address discharge voltage.

However, the present invention is not limited thereto. The address electrodes 150 and 250 can be disposed closest to the first substrate 110, farthest from the first substrate 110, or formed on the second substrate 120. The address electrodes 150 and 250 generate an address discharge that facilitates a sustain discharge between the first discharge electrodes 160 and the second discharge electrodes 170. More specifically, the address electrodes 150 and 250 reduce a voltage for generating the sustain discharge.

Address discharges are generated between scan electrodes and the address electrodes 150 and 250. When the address discharge is completed, positive ions are accumulated on the scan electrodes, and electrons are accumulated on common electrodes, which facilitates the sustain discharge between scan electrodes and common electrodes. The first discharge electrodes 160 and the second discharge electrodes 170 serve as scan electrodes and common electrodes, but the present invention is not limited thereto.

Since the first and second discharge electrodes 160 and 170 do not directly reduce a transmittance ratio of visible light, the first and second discharge electrodes 160 and 170 can be formed of a conductive metal with low resistance such as Al, Cu, etc., instead of ITO, which has a relatively high electrical resistance. Thus, a voltage drop along the length of the first and second discharge electrodes 160 and 170 is small, thus the first and second discharge electrodes 160 and 170 deliver a stable signal.

The first and second discharge electrodes 160 and 170 are buried or disposed in the barrier ribs 114. Therefore, the barrier ribs 114 may be formed of a dielectric substance to prevent direct conduction between the adjacent first and second discharge electrodes 160 and 170 and to prevent the first and second discharge electrodes 160 and 170 from being damaged by collisions between positive ions or electrons and the first and second discharge electrodes 160 and 170, which induces charges and results in accumulated wall charges.

With regard to FIG. 4, protective layers 115 are formed on the sidewalls of the barrier ribs 114. The protective layers 115 are formed via a sputtering of plasma particles. The protective layers 115 prevent the barrier ribs 114, formed of the dielectric substance, and the first and second discharge electrodes 160 and 170 from being damaged. Further, the protective layers 115 emit secondary electrons and reduce the required discharge voltage. The protective layers 115 are formed to have a specific thickness of magnesium oxide (MgO) and are formed on portions of the side surfaces of the barrier ribs 114.

Grooves 110a have a specific depth and are formed on the first substrate 110 facing each of the discharge cells 130. That is, the grooves 110a form an enclosing surface for each of the discharge cells 130 on the first substrate 110. The grooves 110a are irregularly formed in each of the discharge cells 130. The phosphor layers 125 are arranged in the grooves 110a.

However, the arrangement of the phosphor layers 125 of the present invention is not limited thereto. For example, the phosphor layers 125 can be arranged on the sidewalls of the barrier ribs 114. And, the phosphor layers 125 contain a component to generate visible light from ultraviolet light. Each phosphor accepts energy in the form of ultraviolet light or radiation and responds by releasing energy in the form of visible light or radiation. That is, a phosphor layer formed in a red light-emitting discharge cell has a phosphor such as Y(V,P)O₄:Eu; a phosphor layer formed in a green light-emitting discharge cell has a phosphor such as Zn₂SiO₄:Mn, YBO₃:Tb; and a phosphor layer formed in a blue light-emitting-discharge cell has a phosphor such as BAM:Eu. The red light-emitting discharge cell emits visible light in the red region of the visible spectrum when excited by the ultraviolet light discharge created by the first and the second discharge electrodes 160 and 170.

A discharge gas such as Ne, Xe, or a mixture thereof, is filled into the discharge cells 130. The discharge area can be increased and the discharge region can be expanded, thereby increasing the amount of plasma produced in the discharge region, so that the PDP 100 can be operated at a lower voltage. Therefore, even when a gas like Xe that has a high density is used as the discharge gas, the PDP 100 can be operated at a lower voltage, thereby considerably increasing luminous efficiency. However, the conventional PDP 10 cannot be operated at such a low voltage when the Xe gas having a high density is used as the discharge gas.

Any of the first discharge electrodes 160, the second discharge electrodes 170, or the address electrodes may be formed to generally extend in any direction as connected circles about the discharge cells 130 formed such that the centers of the circles form a zigzag, in any direction generally linearly but interrupted by circles formed about the discharge cells 130, or in any direction generally linearly but interrupted by semi-circles about the discharge cells 130.

FIG. 4 specifically illustrates the configuration of electrodes in which the first and second discharge electrodes 160 and 170 extend generally in a direction as connected circles about the discharge cells 130 such that the centers of the circles form a zigzag. Also, the address electrodes 150 are shown to extend in a direction that crosses the direction in which the first and second discharge electrodes generally extend and to be formed to linearly extend in such direction but interrupted by circles formed about the discharge cells 130.

FIG. 5 specifically illustrates the configuration of electrodes in which the first and second discharge electrodes 160 and 170 extend generally in a direction as connected circles about the discharge cells 130 such that the centers of the circles form a zigzag. Also, the address electrodes 250 are shown to extend in a direction that crosses the direction in which the first and second discharge electrodes generally extend and to be formed to linearly extend in such direction but interrupted by semi-circles formed about the discharge cells 130.

A method of manufacturing the PDP 100 will now be described in detail. A substantially flat first substrate 110 is formed, and using etching or sand blasting, grooves 110a are formed in the first substrate 110. Phosphor pastes are coated in the grooves 110a and dried and baked to form the phosphor layers 125.

Sheets for barrier ribs 114 are formed simultaneously with the above process. Here, the sheets for the barrier ribs 114 are sheets formed to contain the barrier ribs 114, the first and second discharge electrodes 160 and 170, and the protective layers 115.

The first and second substrates 110 and 120 and the sheets for the barrier ribs 114 are aligned to perform a sealing process using a frit, etc. In the following process, an exhaust gas and a discharge gas are injected to fabricate the PDP 100. Thereafter, a variety of post-processes, such as aging, can be performed.

A method of operating the PDP 100 will now be described.

An address discharge is effected between the first discharge electrodes 160 and the second discharge electrodes 170 to select one of the discharge cells 130 in which a sustain discharge is effected. A sustain voltage is applied to the first and second discharge electrodes 160 and 170 of the selected discharge cell 130 so that the sustain discharge is effected between the first discharge electrodes 160 and the second discharge electrodes 170. Thus, the discharge gas becomes excited and as an energy level of an excited discharge gas is reduced, ultraviolet radiation is emitted. The emitted ultraviolet radiation excites the phosphor layers 125 so that an energy level of the excited phosphor layers 125 is reduced and visible light is emitted. The emitted visible light forms an image.

In the conventional PDP 10, a sustain discharge is perpendicularly performed between the sustain electrodes 31 and 32 (FIG. 1), thereby relatively reducing the discharge area. Because the sustain electrodes 31 and 32 of the conventional PDP 10 are disposed at one end of the discharge cell, the resultant discharge of the sustain electrodes 31 and 32 inefficiently excites the discharge gas therein. However, the sustain discharge of the PDP 100 is performed with respect to all regions of the discharge cells 130, thereby relatively increasing the discharge area.

The sustain discharge of the PDP 100 forms a closed curve about to the sidewalls of the discharge cells 130 and extends to the center of the discharge cells 130. Therefore, the area where the sustain discharge is effected is increased and the space within the discharge cells 130 is more efficiently utilized. However, in the conventional PDP 10, there is space within each discharge cell that is unable to efficiently assist in emitting light. As a result, the luminous efficiency of the PDP 100 is increased. In particular, since the discharge cells 130 have circular cross-sections, the sustain discharge is uniformly performed with respect to all regions of the discharge cells 130.

Since the sustain discharge is performed in the center of the discharge cells 130, ion sputtering of the phosphor substance from the collisions with charged particles, which is a problem of the conventional PDP 10, is prevented. Thus, a permanent afterimage is not formed despite an image being displayed for a long time.

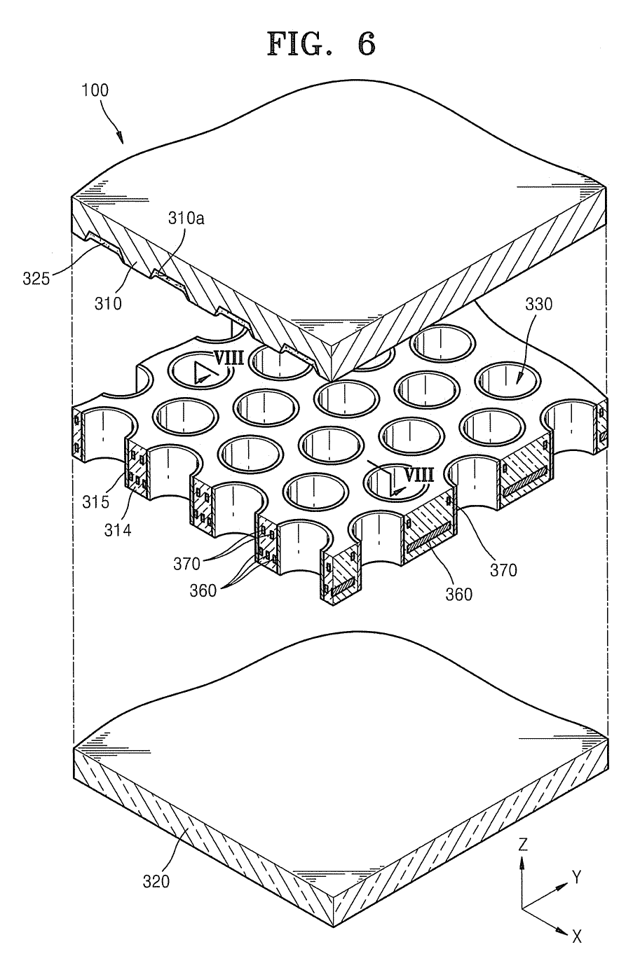

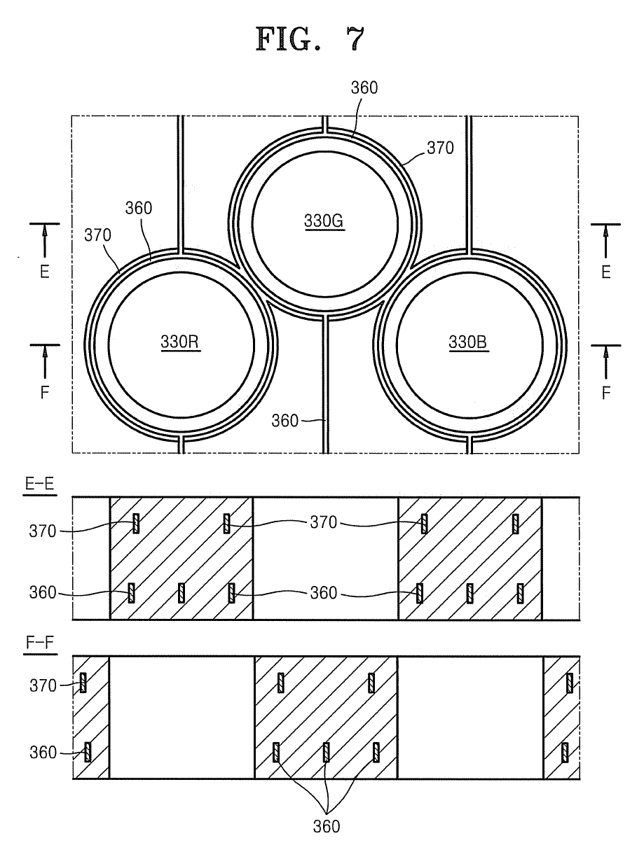

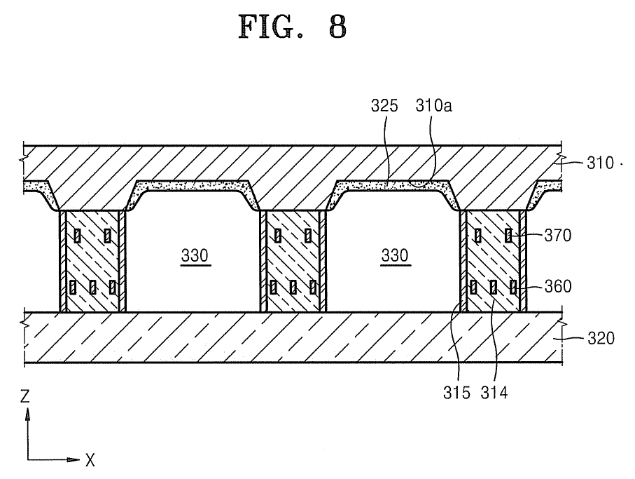

FIG. 6 is a partially exploded perspective view illustrating a PDP 300 according to other aspects of the present invention. FIG. 7 is a cross-sectional view illustrating discharge cells and electrodes of the PDP of FIG. 6. FIG. 8 is a cross-sectional view of the PDP of FIG. 6 taken along a line VIII-VIII of FIG. 6.

Referring to FIGS. 6 through 8, the PDP 300 includes a first substrate 310, a second substrate 320, barrier ribs 314, phosphor layers 325, first discharge electrodes 360, and second discharge electrodes 370.

The second substrate 320 is spaced apart from the first substrate 310 by a predetermined gap and faces the first substrate 310. The barrier ribs 314 define discharge cells 330 so that red, green, and blue sub-pixels 330R, 330G, and 330B, which together form a main pixel, are disposed in a zigzag fashion between the first substrate 310 and the second substrate 320. The discharge electrodes 360 and 370 are disposed in the barrier ribs 314 to surround at least a portion of each of the discharge cells 330.

The phosphor layers 325 are formed of a phosphorescent substance and formed in the discharge cells 330. In detail, grooves 310a are formed on the first substrate 310 facing the discharge cells 330, and then phosphors are coated in the grooves 310a to form the phosphor layers 325.

The first discharge electrodes 360 and the second discharge electrodes 370 are buried or disposed in the barrier ribs 314. The first discharge electrodes 360 and the second discharge electrodes 370 comprise pairs and generate a discharge in the discharge cells 330. The second discharge electrodes 370 extend to surround the discharge cells 330 in a first direction (in an X direction) which crosses a second direction (a Y direction). The second discharge electrodes 370 generally extend in the first direction (the X direction) in a zigzag fashion and connect adjacent discharge cells 330. The second discharge electrodes 370 are essentially connected circles arranged about the discharge cells 330 such that the centers of the circles formed by the second discharge electrodes 370 form a zigzag in the first or X direction. The first discharge electrodes 360 generally extend linearly in the second direction (the Y direction) but are interrupted by circles formed about the discharge cells 330.

The first and second directions (the X and Y directions) are disposed such that the first direction extends parallel to the disposition of the first substrate 310 and the second substrate 320 and the second direction also extends parallel to the first substrate 310 and the second substrate 320 but not parallel to the first direction. And the second discharge electrodes 370 are spaced apart from the first discharge electrodes 360 in the barrier ribs 314 in a third direction (a Z direction). The second discharge electrodes 370 are formed closer to the first substrate 310 than the first discharge electrodes 360. However, the present invention is not limited thereto.

The arrangement of the first discharge electrodes 360 is best illustrated in FIG. 7. The first discharge electrodes 360 generally extend in a direction that crosses the direction in which the second discharge electrodes 370 generally extend. The first discharge electrodes 360 generally extend linearly in a direction but are interrupted by circular portions that surround the individual red, green, and blue sub-pixels 330R, 330G, and 330B. The second discharge electrodes generally extend in the other direction as connected circles arranged about the red, green, and blue sub-pixels 330R, 330G, 330B such that the centers of the formed circles form a zigzag in the other direction.

With regard to FIG. 7, each of the second discharge electrodes 370 is in the shape of a circular ring. However, the present invention is not limited thereto. The first and second discharge electrodes 360 and 370 may have a variety of shapes such as a tetragonal loop and may substantially have the same shape as the cross-sections of the discharge cells 330.

One of the first discharge electrodes 360 and the second discharge electrodes 370 may serve as a scan electrode in an address period and a sustain electrode in a sustain period, and the other of the first discharge electrodes 360 and the second discharge electrodes 370 may serve as an address electrode in the address period and a sustain electrode in the sustain period.

The discharge cells 330 are disposed in a zigzag fashion so that cross-sectional area of the discharge cells 330 is maximized with respect to a given panel area, which increases brightness and discharge efficiency. Essentially, a discharge density is increased as the cross-sectional area of the discharge cells 130 increases with respect to a given panel area.

In particular, as all of the electrodes at least partially surround each discharge cell 330, the discharge intensity and the degree of luminosity are determined according to the cross-sectional area, here the diameter, of each discharge cell 330. In the ring discharge type PDP 300 in which electrodes surround each discharge cell 330, red, green, and blue sub-pixels 330R, 330G, and 330B, respectively, are disposed in a zigzag fashion, thereby maximizing the cross-sectional areas of the discharge cells 330. Referring to FIG. 7, the first discharge electrodes 360 and the second discharge electrodes 370 are connected in a zigzag fashion according to the red, green, and blue sub-pixels, 330R, 330G, and 330, respectively.

The discharge cells 330 are red, green, or blue sub-pixels 330R, 330G, and 330B according to types of the phosphor layers 325. Each group of red, green, and blue sub-pixels 330R, 330G, and 330B constitutes a main pixel. The discharge cells 330 are disposed so that lines connecting centers of the red, green, or blue sub-pixels 330R, 330G, and 330B cross each other at predetermined angles. The lines can form triangles. Each triangle formed may have inside angles of 60 degrees so that the discharge cells 330 can be disposed in the shape of a delta.

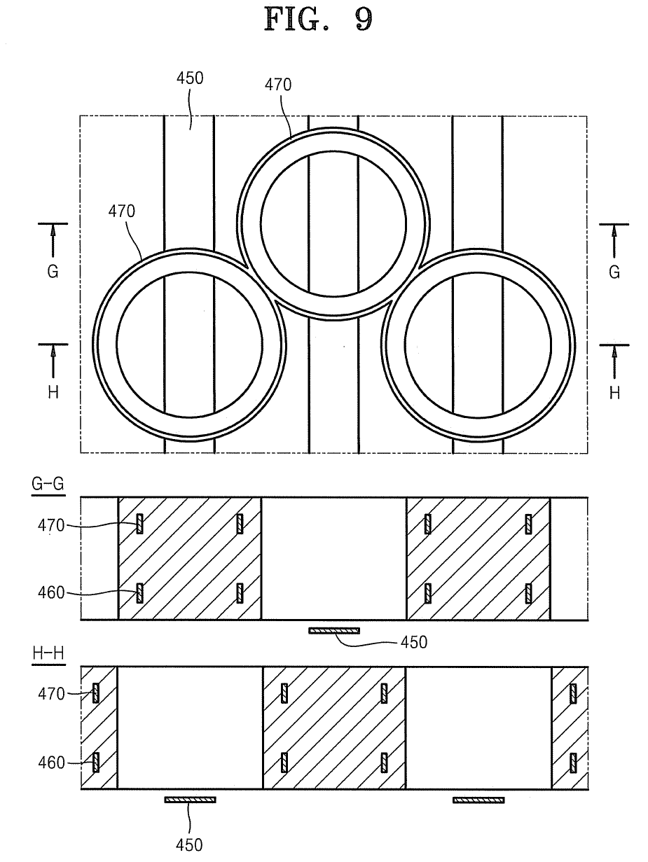

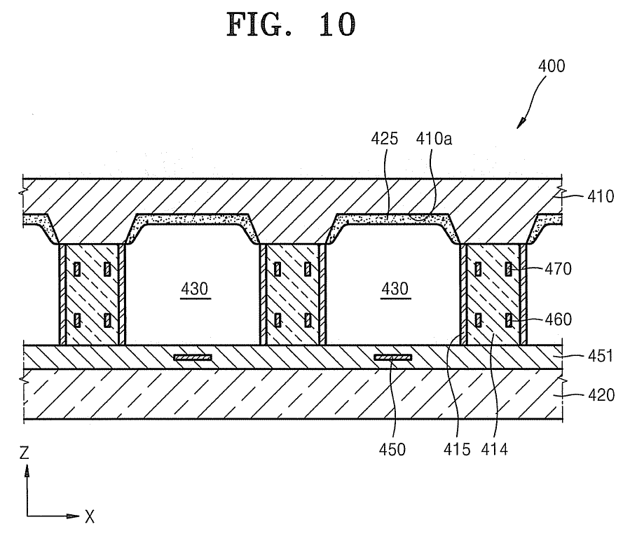

FIG. 9 is a cross-sectional view illustrating discharge cells and electrodes of a PDP 400 according to aspects of the present invention. FIG. 10 is a cross-sectional view of the PDP of FIG. 9.

Referring to FIGS. 9 and 10, the PDP 400 includes a first substrate 410, a second substrate 420, barrier ribs 414, first discharge electrodes 460, second discharge electrodes 470, address electrodes 450, a dielectric layer 451, and phosphor layers 425. The following description repeats elements discussed above, and, as such, duplicative descriptions are omitted.

Discharge cells 430 are red, green, or blue sub-pixels 430R, 430G, and 430B according to types of phosphor layers 425. Each group of red, green, and blue sub-pixels 430R, 430G, and 430B forms a main pixel. The discharge cells 430 are disposed so that lines connecting the centers of the red, green, or blue sub-pixels 430R, 430G, and 430B cross each other at predetermined angles. The lines can form triangles. Each triangle may have inside angles of 60 degrees so that the discharge cells 430 can be disposed in the shape of a delta.

The first discharge electrodes 460 and the second discharge electrodes 470 are buried or disposed in the barrier ribs 414. The first discharge electrodes 460 and the second discharge electrodes 470 comprise pairs and generate a discharge in the discharge cells 430. The first discharge electrodes 460 and the second discharge electrodes 470 extend to surround the discharge cells 430 generally in a first direction and are formed as connected circles arranged about the red, green, and blue sub-pixels 430R, 430G, and 430B such that the centers of the formed circles form a zigzag in the first direction. The second discharge electrodes 470 are spaced apart from the first discharge electrodes 460 in the barrier ribs 414 in a direction perpendicular (in a Z direction) to the first substrate 410.

The address electrodes 450 are formed on the second substrate 420 and extend to cross the first discharge electrodes 460 and the second discharge electrodes 470. The dielectric layer 451 is formed on the second substrate 420 to protect the address electrodes 450 and is formed of a dielectric substance.

Aspects of the present invention relate to a plasma display panel that generates a plasma discharge. However, the present invention is not limited thereto and can be applied to various display panels.

The plasma display panel according to aspects of the present invention has a structure in which discharge electrodes surround each discharge space and discharge spaces are disposed in a zigzag fashion at a predetermined angle with respect to a horizontal axis, which increases discharge area, thereby increasing discharge intensity and luminous efficiency of the plasma display panel.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A plasma display panel, comprising:
a first substrate;
a second substrate spaced apart from the first substrate and to face the first substrate;
a plurality of barrier ribs disposed between the first substrate and the second substrate to define a plurality of discharge cells between the first and second substrates; and
a plurality of pairs of discharge electrodes disposed in the barrier ribs to surround at least a portion of each of the discharge cells,
wherein the discharge cells are disposed in a zigzag fashion.

2. The plasma display panel of claim 1, wherein the discharge cells have circular or oval cross-sections.

3. The plasma display panel of claim 1, wherein each of the discharge cells is a sub-pixel, a plurality of sub-pixels forms a main pixel, and the discharge cells are disposed so that the sub-pixels form triangles in the main pixel.

4. The plasma display panel of claim 3, wherein the discharge cells are disposed so that each triangle has inside angles of 60 degrees.

5. The plasma display panel of claim 1, further comprising: grooves formed on the first substrate to face the discharge cells, and phosphors coated in the grooves to form phosphor layers.

6. The plasma display panel of claim 1, wherein each of the pairs of discharge electrodes comprises a first discharge electrode and a second discharge electrode, and the first discharge electrodes are spaced apart from the second discharge electrodes in a direction from the first substrate to the second substrate.

7. The plasma display panel of claim 6, wherein the first discharge electrodes and the second discharge electrodes extend substantially parallel to each other in a first direction.

8. The plasma display panel of claim 7, further comprising:
address electrodes disposed in the barrier ribs and spaced apart from the pairs of discharge electrodes in the direction from the first substrate to the second substrate and extending to cross the pairs of discharge electrodes,
wherein the address electrodes surround at least a portion of each of the discharge cells formed in a direction in which the address electrodes extend.

9. The plasma display panel of claim 7, further comprising: address electrodes formed on the second substrate to extend in a second direction to cross the pairs of discharge electrodes.

10. The plasma display panel of claim 9, further comprising: a dielectric layer formed on the second substrate to protect the address electrodes and the dielectric layer is formed of a dielectric substance.

11. The plasma display panel of claim 6, wherein the first discharge electrodes extend in a first direction and the second discharge electrodes extend in a second direction, and the second direction crosses the first direction.

12. A plasma display panel comprising:
a first substrate;
a second substrate spaced apart from the first substrate and to face the first substrate;
a plurality of barrier ribs disposed between the first substrate and the second substrate to define a plurality of discharge cells between the first and second substrates;
a plurality of pairs of discharge electrodes disposed in the barrier ribs to surround at least a portion of each of the discharge cells; and
phosphor layers formed in the discharge cells and formed of a phosphor substance; and
wherein the discharge cells are red, green, or blue sub-pixels, with each group of red, green, and blue sub-pixels forming a main pixel, and the discharge cells are disposed so that lines that connect centers of the red, green, or blue sub-pixels form triangles in the main pixel.

13. The plasma display panel of claim 12, wherein the discharge cells are disposed so that each triangle has inside angles of 60 degrees.

14. The plasma display panel of claim 12, wherein the discharge cells have circular or oval cross-sections.

15. The plasma display panel of claim 12, wherein grooves are formed on the first substrate to face the discharge cells, and phosphors are coated in the grooves to form the phosphor layers.

16. The plasma display panel of claim 12, wherein each of the pairs of discharge electrodes comprises a first discharge electrode and a second discharge electrode, and the first discharge electrodes are spaced apart from the second discharge electrodes in a direction from the first substrate to the second substrate.

17. The plasma display panel of claim 16, wherein the first discharge electrodes and the second discharge electrodes extend substantially parallel to each other in a first direction.

18. The plasma display panel of claim 17, further comprising: address electrodes disposed in the barrier ribs and spaced apart from the pairs of discharge electrodes in the direction from the first substrate to the second substrate.

19. The plasma display panel of claim 17, further comprising: address electrodes formed on the second substrate in a second direction to cross the pairs of discharge electrodes.

20. The plasma display panel of claim 19, further comprising: a dielectric layer formed on the second substrate to protect the address electrodes and the dielectric layer is formed of a dielectric substance.

21. The plasma display panel of claim 16, wherein
the first discharge electrodes extend in a first direction, and the second discharge electrodes extend in a second direction, and
the second direction crosses the first direction.
